(19) United States
(12) Patent Application Publication
(10) Pub. No.: US 2008/0313025 A1
(43) Pub. Date: Dec. 18, 2008

(54) Designed Process Testing Method

(75) Inventor: Anando A. Chowdhury, Monmouth Junction, NJ (US)

Correspondence Address: LAW OFFICES OF GRADY L. WHITE, LLC, 10605 Concord Street , SUITE 440, Kensington, MD, 20895, US

(73) Assignee: Merck & Co., Rahway, NJ (US)

(21) Appl. No.: 12/139,770

(22) Filed: Jun. 16, 2008

Related U.S. Application Data
(60) Provisional application No. 60/944,492, filed on Jun. 16, 2007.

(51) Int. Cl. G06Q 10/00

(52) U.S. Cl. 705/11

(57) ABSTRACT

A method for identifying deficiencies in a new or improved designed process comprising the steps of collecting implementation data pertaining to agents, resources, environment and strategy associated with the designed process, identifying a historical event to serve as a context for evaluating the designed process, compiling historical event data for the historical event, including information pertaining to agents, resources, environment, strategy and outcomes associated with the historical event, defining a model space for a simulation based on the implementation data and the historical event data, defining a performance requirement for the simulation, and conducting the simulation within the model space. The model space definition comprises a plurality of roles each having a predefined character set. During the simulation, human role players perform acts and carry out steps or functions in accordance with the predefined character sets. Participants in or monitors of the simulation identify results in respect to achieving the performance requirement, as well as deficiencies that are at least in part responsible for the results. When there are multiple parties responsible for developing, managing and carrying out the newly designed process, the present invention produces consensus and shared understanding among those multiple parties and facilitates developing corrective actions for the identified deficiencies.

### CROSS-REFERENCE TO RELATED APPLICATIONS

This application is related to and claims priority under 35 U.S.C. §119 to provisional application No. 60/944,492, filed on Jun. 16, 2007, which is incorporated into this application in its entirety by this reference.

### FIELD OF ART

The present invention relates generally to a process for testing and evaluating a designed process involving human interaction, judgment and decision-making.

### RELATED ART

Developing a new or improved product or process, whether for business, governmental or other purposes, typically involves four stages: conception, design, testing and optimization. For newly designed or improved products, the testing stage is usually carried out by producing one or more prototypes and observing whether the prototypes operate as intended when placed in an appropriate test environment. For new or improved designed processes, however, it has been found that producing a suitable prototype, and creating an appropriate test environment is much more difficult, especially when the new or improved design process involves or requires a significant amount of human interaction, judgment and decision-making. Designed processes for completing corporate transactions, for evaluating product safety, for rendering committee or governmental decisions, for obtaining regulatory agency approvals, for providing customer service or support, and for selecting and ranking personnel, represent just a few examples of designed processes that are difficult to test.

The purpose of testing a designed process is to confirm expected results for the designed process, as well as to identify and analyze results that may not have been anticipated, recognized or fully-appreciated during the conceptualization and design stages for the designed process. Some of the unanticipated, unrecognized or underappreciated results may be considered to be positive, such as, for example, unexpected savings in time, money or other resources, unanticipated increases in value, sales or profits, or unexpected or underappreciated satisfaction or goodwill associated with the new or improved designed process. However, designed processes also frequently have associated with them unanticipated, unrecognized or underappreciated results that may be considered negative, damaging, or, in some cases, destructive. Unanticipated negative, damaging and destructive results may include, for instance, unexpected problems, obstacles, shortcomings or injuries associated with carrying out the designed process, as well as unexpected expenses, delays, waste or lost opportunities.

In addition, new or improved designed processes frequently comprise a plurality of discrete elements which may be developed or carried out separately by different individuals, groups or departments in an organization. Sometimes the different individuals, groups or departments have different motives, goals, responsibilities or performance measures for the new or improved designed process, some of which may not be expressed, appreciated or recognized by all of the parties involved in creating or carrying out the designed process. In this situation, other negative unanticipated results, such as misunderstandings, false impressions, apprehension, undue criticism and anxiety may become associated with the new or improved design process. These unanticipated negative results, although less tangible, can become so severe and so pervasive in a company or organization that they tend to undermine or counteract the goals and benefits the new or improved designed process was meant to achieve.

Accordingly, there is considerable need for a systematic and reliable method for testing new or improved designed processes, especially those new or improved designed processes that involve a significant amount of human interaction, judgment and decision-making, and for identifying deficiencies in the designed process tending to bring about negative results that undermine or prevent achieving the objectives or benefits of the new design or improvement. What is also needed is a method for testing new or improved designed processes which produces consensus and shared understanding among the parties responsible for developing, managing and carrying out the new or improved designed process.

### SUMMARY OF THE INVENTION

The present invention addresses the aforementioned needs at least in part by providing a method for identifying deficiencies in a designed process. In general, the method comprises: (1) collecting implementation data comprising information pertaining to agents, resources, environment and strategy associated with carrying out the designed process; (2) identifying a historical event to serve as a context for evaluating the designed process; (3) compiling historical event data for the historical event, the historical event data including information pertaining to agents, resources, environment, strategy and outcomes associated with the historical event; (4) defining a model space for a simulation based on the implementation data and the historical event data, the model space including a plurality of roles corresponding respectively to a plurality of agents associated with the historical event, wherein each role in the plurality of roles comprises a predefined character set; (5) defining one or more performance requirements for the simulation; and (6) conducting the simulation within the model space, the simulation comprising: (a) a human role player for each role performing one or more acts in accordance with the predefined character set for the role, (b) identifying a result in respect to achieving the performance requirement, and (c) identifying a deficiency in the designed process that is at least in part responsible for the result.

A predefined character set for a role includes one or more characteristics assigned to an active agent participating in the simulation. Thus, a predefined character set for a particular role may comprise, for example, a set of facts considered to be within the agent's knowledge during the historical event, a set of tasks or duties considered to fall within the agent's area of responsibility during the historical event, a set of decision powers (or rights) considered to fall within the agent's scope of authority during the historical event, a set of actions considered to be within the agent's capacity during the historical event, or a set of resources considered to be available to the agent during the historical event. Some elements of a predefined character set for a particular role may be defined or expressed in a negative manner. Thus, the predefined character set for role may include, for instance, facts considered to be outside the agent's knowledge, tasks or duties considered to fall outside the agent's area of responsibility, decision powers considered to fall outside the agent's scope of authority, actions considered to fall outside the agent's capacity, or resources considered to be unavailable to the agent during the historical event.

Human role players in the simulation simulate the participation and contributions of the various agents associated with the selected historical event in a manner that accords with the predefined character set (i.e., knowledge, authority, responsibilities, capabilities and resources) available or not available to those agents during the historical event. The human role players perform their roles, for example, by doing one or more acts or making one or more decisions that adhere to the elements of the predefined character sets for their roles.

The deficiencies identified during the simulation may be recorded so that participating (and nonparticipating) parties can review the deficiencies and identify tasks and corrective actions to address them. According to some embodiments of the invention, for example, the deficiencies are recorded on a Kaizen newspaper, which comprises a list of deficiencies, corrective actions and parties responsible for carrying out the corrective actions. Reviewing the recorded deficiencies and corrective actions, and assigning responsible parties for carrying out corrective actions, may occur during or after the simulation. However, addressing and correcting deficiencies after the simulation is completed is strongly preferred.

In accordance with one embodiment of the present invention, defining the model space comprises at least one of the following actions: defining a time period for conducting the simulation, defining a set of rules for the simulation, specifying a location, environment or schedule for the simulation, identifying a set of resources for the simulation, or identifying a set of active agents for the simulation. In some embodiments, defining the model space may comprise carrying out all of these actions.

In accordance with one embodiment of the invention, a computer model representing the model space may be generated and utilized to determine a result or status in respect to achieving the specified performance requirement. In addition, perturbations may be introduced during the simulation in order to ascertain how such perturbations will impact the overall designed process.

In some embodiments, the method further comprises incorporating into the implementation data information associated with implementing the corrective action, thereby producing new implementation data; incorporating the new implementation data into the model space, thereby producing a new model space; and conducting a second simulation using the elements of the new model space in order to judge how implementing the corrective action influences progress towards meeting or achieving the specified performance requirements.

Embodiments of the invention may be put to beneficial use in testing and evaluating new and improved processes in a variety of settings and contexts, including for example, processes for managing a business, processes for developing or launching new products and processes for conducting scientific research. In these and other contexts, embodiments of the invention are capable of identifying deficiencies with a level of quality, integrity, speed and efficiency heretofore unachieved by previous methods.

### BRIEF DESCRIPTION OF THE DRAWINGS

The present invention and various aspects, features and advantages thereof are explained in detail below with reference to exemplary and therefore non-limiting embodiments and with the aid of the drawings, which constitute a part of this specification and include depictions of the exemplary embodiments. In these drawings:

FIG. 1 contains a unified modeling language (UML) activity diagram illustrating the steps that may be performed in order to practice an embodiment of the present invention.

FIGS. 2 and 3 contain tables summarizing implementation and historical event data collected in an exemplary scenario where an embodiment of the present invention is applied.

FIG. 4 contains a graphical representation of a model space definition developed for the exemplary scenario associated with FIGS. 2 and 3 according to an embodiment of the present invention.

### DETAILED DESCRIPTION OF EXEMPLARY EMBODIMENTS

With reference to the figures, a detailed discussion of exemplary embodiments of the invention will now be presented. In the detailed discussion, numerous specific details concerning the exemplary embodiments are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

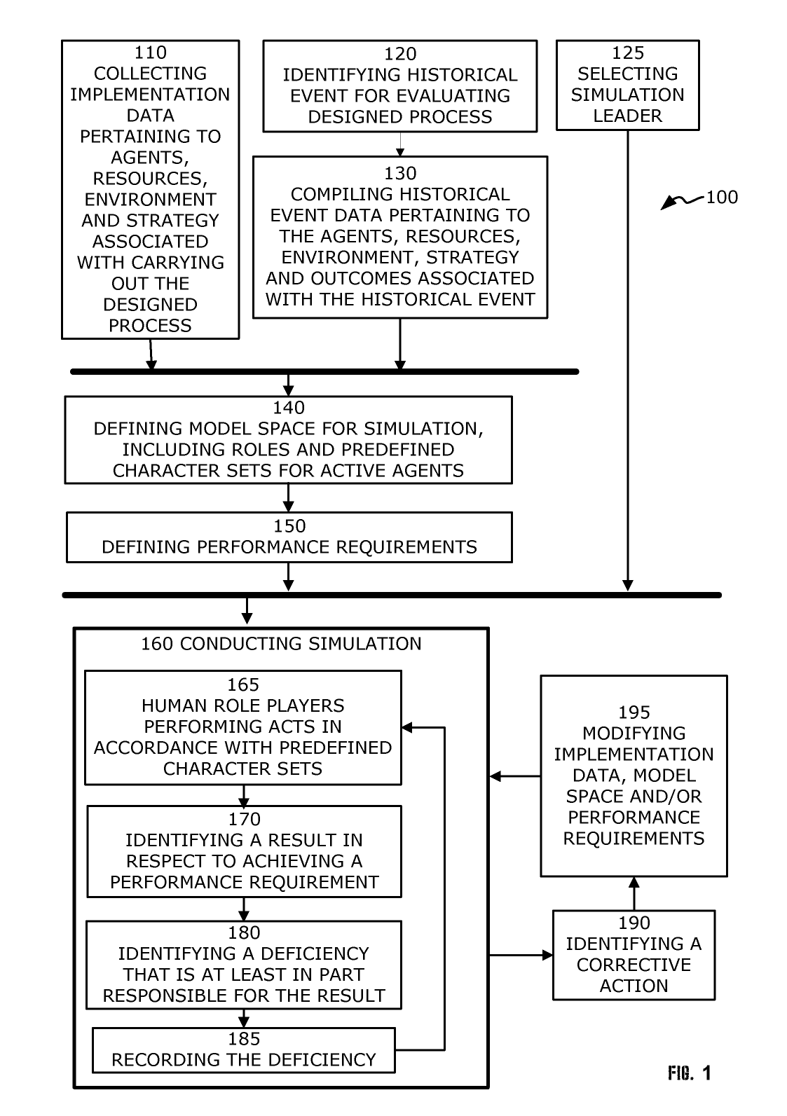

FIG. 1 contains a UML activity diagram 100 illustrating the steps that may be performed to implement an embodiment of the present invention. As with most UML activity diagrams, FIG. 1 contains synchronization bars (thick horizontal lines where two or more vertical arrows begin or terminate) to show where two or more activities that may be performed concurrently must stop and wait for each other. As shown in FIG. 1, activity diagram 100 includes the steps of collecting implementation data pertaining to agents, resources, environment and strategy associated with carrying out the designed process (step 110), identifying a historical event for evaluating the designed process (step 120), compiling historical event data pertaining to the agents, resources, environment, strategy and outcomes associated with the historical event (step 130), defining a model space for a simulation (step 140), defining performance requirements for the simulation (150) and conducting the simulation (step 160).

As shown in FIG. 1, the step of conducting the simulation includes several substeps that me be performed multiple times before the simulation step is completed, including human role players performing acts in accordance with the predefined character sets for each role (step 165), identifying a result in respect to achieving a performance requirement (step 170) and identifying a deficiency that is at least in part responsible for the result (step 180). The simulation step may optionally include the step of recording the deficiency (step 185). Other optional steps that may occur before and after conducting the simulation include selecting a simulation leader (step 125), identifying a corrective action for the deficiency (step 190) and modifying the implementation data, the model space and/or performance requirements to incorporate the corrective action (step 195). Each of these steps will be discussed in more detail below.

Collecting Implementation Data

It has been found that, on average, as much as forty percent of the implementation information for most designed processes, although frequently-used and thought to be well-understood, has never been documented in writing or any other fixed means of expression. Thus, as much as forty percent of the information describing the agents, resources, environment and strategies required to implement a designed process in what is considered to be the most effective manner remains undocumented. Consequently, this valuable implementation data may be disseminated only by means of verbal communication, demonstrations or on-the-job training. To deal with this problem, the first step of the present invention (represented by step 110 in FIG. 1) comprises collecting implementation data pertaining to the agents, resources, environment and strategies for the designed process. This valuable implementation data for the designed process, some of which may not have been previously documented, is compiled into a reliable and comprehensive form that can easily be shared and understood by all of the participants of a planned simulation.

Implementation data pertaining to the agents of a designed process includes information about the individuals, groups, departments, committees, organizations and/or governmental bodies who are responsible for carrying out the designed process, who may influence how the designed process is carried out, or who may be affected by it when it is carried out. In the business context, agents may include, for instance, people and groups of people, such as designers, testers, builders, programmers, managers, salesmen, engineers, customers and competitors, to name just a few examples.

Implementation data pertaining to the resources of the designed process includes, for example, information about the tools and artifacts needed to carry out the designed process, such as time, money, raw or processed materials, equipment, stationary, computers, software programs, trucks, communications devices, clothing or any other resource considered necessary or desirable for carrying out the designed process.

Implementation data pertaining to the environment for the designed process may include, for example, information about the setting, location, weather, temperature requirements, operational parameters, culture or politics surrounding or influencing the designed process in ways that need to or should be taken into account.

Implementation data pertaining to the strategies for the designed process may include any information about the strategies, tactics, guidelines, policies, schemes, objectives, goals or maneuvers associated with carrying out the designed process. Such information may include, for example, information about certain approaches or tactics, such as renting equipment instead of buying it, selecting one supplier over another, establishing manufacturing or support facilities in certain locations, providing hardware free of charge in order to generate revenue from selling services associated with the free hardware, lobbying Congress to pass, change or repeal laws tending to support or complicate achieving certain business objectives, licensing products instead of selling them, filing patent applications, initiating litigation, etc.

The step of collecting implementation data for the designed process may be carried out, for example, by collecting or producing write-ups, descriptions or instructions for the designed process, by collecting or producing diagrams, maps and flow charts describing the designed process, by collecting or producing audio and video recordings of one or more subject matter experts describing or performing the designed process, or by using some combination of one or more of these methods. In addition (or as one alternative), this step may be carried out by bringing one or more subject matter experts for the designed process to the simulation. A significant benefit of this first step is that it virtually forces the designed process designers, teachers, demonstrators, implementers and subject matter experts to think very carefully and comprehensively about all of the strategies, tactics, agents, resources and tools pertaining to the designed process and to share this information with the simulation organizers and participants.

Preferably, but not necessarily, the collected implementation data is stored in a computer-readable database, where it can be indexed, categorized, organized and formatted to facilitate quick and easy access, searching and sharing of the data by simulation organizers and participants. However, it should be noted that the use of computer technology is not strictly required. The inventor of the present invention has found, for example, that written papers, manuals, books, reference binders, display boards, flip charts and other tangible forms of documentation may also serve as very effective tools for storing and sharing the implementation data.

Identifying a Historical Event to Serve as a Context for Evaluation

The inventor of the present invention has recognized that evaluating a new or improved designed process in a vacuum-that is, without the variables, interruptions, perturbations and constraints typically imposed by or experienced during real world situations-nearly always fails to reveal at least a few significant deficiencies that only reveal themselves after the designed process is put into practice in the real world. Therefore, the next step (step 120 in FIG. 1) is to select a historical event or scenario that is representative of or similar to the situations, events or scenarios likely to be encountered when the designed process is utilized. Examples of historical events that might be used may include, for instance, the history of a product previously developed or manufactured, the history associated with a judicial, governmental or committee decision previously rendered, or the history of a customer service interaction or population of customer service interactions. Say, for example, that the designed process comprises a new or improved process for interacting with customers over the telephone while providing customer support services. Then one example of a relevant historical event that could serve as a suitable context for evaluating the new or improved designed process could be a collection of customer service interactions from a time period that began prior to the implementation of the designed process. The historical event selected does not need to have reached a final conclusion yet.

Compiling Historical Event Data

After a relevant historical event is identified, the third step (step 130 in FIG. 1) comprises compiling information pertaining to the agents, resources, environment, strategy and outcomes associated with the selected historical event. Continuing with the previous example, for instance, if the selected historical event is a collection of previous customer service interactions from a previous time period, then the step of compiling historical event data might be accomplished by retrieving and analyzing customer call records, as well as recorded customer service telephone conversations for the selected time period, in order to accumulate information about the agents, resources, strategies and outcomes associated with the customer service incidents documented in those customer call records and recorded telephone conversations. In this case, historical event data pertaining to the agents associated with the selected historical event may comprise, for example, information about the customers and customer service representatives involved in the incidents. Historical event data pertaining to resources may include, for example, descriptions of the call center networks, computer systems, diagnostic routines and troubleshooting manuals used to handle the incidents in the historical event.

Historical event data pertaining to the strategies for the historical event may include, for example, information pertaining to a decision to provide telephone support twenty-four hours a day, seven days a week. Historical event data pertaining to outcomes may include, for instance, survey results indicating what percentage of customers were satisfied by their customer support experiences during the time period documented in the call records and recorded telephone conversations. The compiled historical event data adds layers of context and variability concomitant with real world human interactions, real world timelines and real world resource constraints, and therefore enriches the evaluation of the designed process in ways not achievable when the designed process is tested or evaluated without incorporating this data into the test or evaluation.

Defining a Model Space for a Simulation

Model space encompasses the agents, resources, environments and strategies that will be incorporated into the simulation, as well as the rules and conditions that will apply while the simulation is conducted. The next step in the present invention (step 140 in FIG. 1) comprises defining these agents, resources, environments, strategies, rules and conditions. The definition of the model space is derived at least in part from the collected implementation data, as well as the compiled historical event data. Therefore, the model space definition will usually encompass both forward-looking and backward-looking variables. While some elements of the model space may be defined to adhere or correspond to the agents, resources, environment, strategies and conditions that existed at the time of the historical event, it will usually be necessary or desirable to modify certain model space elements or to add or delete elements in order to account for the conditions, features or resources required for the new or improved designed process. Accordingly, the model space definition may include agents, resources, environment variables or strategies that did not exist or were not available during the selected historical event.

Defining the model space for the simulation comprises defining the set of agents that will interact with each other during the simulation, as well as the resources, environment and strategies available to them. This task typically includes examining the historical event data to identify the set of agents that interacted with each other during the historical event, the roles played by each agent during the historical event and the set of relevant characteristics, resources and strategies each agent had during the historical event. But the historical event data alone may not have all of the information about agents, resources and strategies required by the designed process. For example, the designed process may call for imposing significant changes in the roles or characteristics of some of the agents, as well as significant changes in the manner in which some of the agents interact with each other, or significant changes in the manner the agents take advantage of the resources available to them. Information about new agents, changed agent roles, changed characteristics and changed uses for resources will usually be obtained by consulting the designed process implementation data. In addition, it is not always necessary or desirable to use all of the agents from the selected historical event or the new or improved designed process during the simulation. Therefore, some agents that were active during the historical event and/or some agents that are expected to be active during the implementation of the new or improved design process will not be represented in the model space.

After defining the set of agents and roles that will interact with each other during the simulation, each active role is assigned to a human role player who will be responsible for acting out (or “simulating”) the agent's role in the simulation. Depending on the circumstances and objectives of the simulation, the individual characteristics of each role in the simulation (and therefore each human role player) may be defined at varying levels of specificity, as well as in multiple dimensions. In some cases, for example, it may be necessary or advantageous not only to define which agents will interact with each other during the simulation, but also to specify, for one or more agents participating in the simulation, the scopes of knowledge, responsibility, authority and resources associated with each agent. Defining the model space may also include defining when, where and how certain agents are allowed (or not allowed) to interact with each other.

Suppose, for example, that the designed process to be tested comprises a new or improved process for managing onsite customer support calls carried out by a staff of field customer support agents. Suppose further that the historical event selected for this simulation comprises a collection of previous onsite customer support incidents. If the new or improved process calls for providing the staff of field customer support agents with resources that were not available during the selected historical event, such as cellular telephones, wireless laptop computers and Internet access to a web site to download software upgrades, then the model space for the simulation may need to be defined so that it includes these additional resources. Similarly, if the new or improved process calls for increasing or reducing the size of the staff of field customer support agents, or replacing field agents with telephone support agents operating out of a centralized customer support call center, then these agents and conditions also need to be reflected in the defined model space for the simulation.

Notably, it is not necessary that there be a one-to-one correspondence between human role players and active agents in the simulation. Some human role players may be assigned to perform multiple roles and some roles may be performed by multiple human role players. Often it will be necessary or desirable to assign a single human role player to performing the collective role of an entire class of individuals, an entire organization or a group of organizations.

Defining the model space may also include planning, organizing, coordinating or describing the logistics for the simulation. Thus, defining the model space for the simulation may include, for example, defining a time period for conducting the simulation, specifying a location for the simulation, defining an environment or facility for the simulation, identifying a set of resources for the simulation or defining a schedule for the simulation.

Typically, although not necessarily, defining the model space will also include defining a number of different time elements. These time elements may include, for example, the defined time period for conducting the simulation and the defined schedule for the simulation. Notably, the defined time period for conducting the simulation and the defined schedule for the simulation do not necessarily have to be of equal or comparable size. Thus, defining the time period for conducting the simulation typically comprises specifying the length of time associated with the occurrence of a historical or future event to be simulated (as in “the simulation will cover the relevant events and milestones that occurred during the twelve-month product development cycle for the XYZ product”), while defining the schedule typically comprises specifying the real world time and duration for the simulation (as in, “the simulation will take place on next Tuesday from 8 a.m. to 8 p.m.”). In this example, defining the model space may also include tasks such as mapping virtual time for the simulation to real world time (as in, “each hour of the simulation will cover approximately 1 month of the product development cycle”).

Defining the model space for the simulation also includes identifying the resources for the simulation. Among other things, resources may include, for example, virtual world resources, such as the quantity of time, space, raw materials, personnel and money certain agents will have at their disposal or control during the simulation, as well as real world resources, such as the quantity of time and money will be available and consumed in the real world (e.g., for renting meeting space) for the purpose of conducting the simulation.

Defining Performance Requirements

The next step (step 150 in FIG. 1) is to define one or more performance requirements for the simulation. A performance requirement may comprise any goal, objective, milestone, expected output or measure of success for the simulation. Thus, examples of performance requirements include things such as achieving regulatory agency approval for a new product, delivering a product or service to a consumer, attaining a specified amount of revenue in a business enterprise or completing a corporate transaction. A performance requirement may also be expressed by reference or comparison to elements of the compiled historical data pertaining to the historical event. For instance, if the goal or objective of a designed process is to reduce the time or resources required to develop a product or deliver a service, then the reduction in time or resources (as compared to the time or resources required during the historical event) also may serve as a legitimate performance requirement for the simulation. Typically, although not necessarily, the performance requirement is defined by reference to or comparison with at least one of the outcomes of the historical event.

Recalling the previous example, wherein the designed process to be tested comprises a new or improved process for interacting with customers while delivering customer support, the performance requirements defined for the simulation may include, for example, a reduction in the average length of time required for customer interactions, a reduction in the average number of follow-up customer interactions (i.e., second and third customer interactions) required for each first customer interaction, or a reduction in the number of customer support agents required to handle customer interactions during a specified period of time.

Conducting the Simulation

The next step (step 160 in FIG. 1) comprises conducting the simulation within the defined model space with each human role player performing acts in accordance with the predefined character sets for each assigned role (substep 165). Performing an act in accordance with the predefined character set includes performing any positive or negative act on behalf of the agent, such as, for example, making or refusing to make an affirmative decision on any subject during the simulation, carrying out or refusing to carry out a duty or responsibility of the agent, or issuing or refusing to issue a statement on behalf of the agent, all according to the predefined characteristics (i.e., knowledge, skill, mandate, etc.) associated with that role. As previously stated, some human role players participating in the simulation may be responsible for performing multiple roles and some roles may be performed by multiple human role players.

For example, if a predefined character set for an active agent in the simulation dictates that the active agent possesses the motivation, knowledge, skill and resources required to perform a certain function associated with the designed process, then the human role player performing the role of that active agent would be expected to perform that function (or simulate performing that function) during the simulation if given the opportunity to do so. On the other hand, if the predefined character set for the active agent dictates that the active agent possesses the motivation to perform the function, but lacks the knowledge, skill or resources required to perform the function, then the human role player would be expected to refrain from performing the function, or alternatively, to suggest or insist that the function be carried out by another active agent in the simulation who possesses or controls the knowledge, skill or resources required.

Frequently, the only party who fully recognizes or appreciates the problems, obstacles, advantages and disadvantages associated with carrying out a particular step of a designed process in a particular manner or supplying a particular resource is the party who is responsible for carrying out that particular step or supplying that particular resource. One benefit of running the simulation event according to the principals of the present invention is that it provides an exceptional forum for the participants to attain a shared understanding and appreciation for some of the problems, obstacles, advantages and disadvantages that may be associated with implementing some of the steps, strategies and tactics of the designed process. This shared understanding and appreciation seldom occurs in the absence of the discussions and interactions brought about as a result of conducting a simulation together as a group.

The step of conducting the simulation is typically referred to as running or hosting a “simulation event.” For purposes of the present invention, running or hosting the simulation event may be described as simulating the designed process using a model space that encompasses elements of the selected historical event. However, it is usually equally accurate to describe the step of running the simulation event as simulating the historical event using a model space that encompasses elements of the new or improved designed process. Either description, and both of them, would fall within the scope of the present invention.

Identifying Results

While the simulation proceeds, progress is monitored and measurements are taken to determine what results (i.e., consequences, outcomes or effects), if any, the designed process may be having with respect to one or more defined performance requirements. Accordingly, step 170 in FIG. 1 is to identify a result in respect to the defined performance requirement, which result typically reveals whether implementation of the designed process will likely advance or undermine the intended goals and objectives of the designed process. So, for example, if the defined performance requirement for the simulation is to reduce the average length of time required for customer interactions, then the length of time required to conclude each customer interaction during the simulation may be monitored, measured and recorded, so as to enable calculating the average customer interaction time for the simulation. In this instance, the average customer interaction time is one result that may be identified in respect to the defined performance requirement. It is usually possible to monitor and measure a plurality of results in respect to a plurality of defined performance requirements. Some of the results may turn out to be negative relative to the defined performance requirements, while other results may be considered to be unexpectedly positive.

Typically, there will be several ways to characterize and record results in respect to a defined performance requirement. For the above-described example, wherein the defined performance requirement is to reduce the average customer interaction time, another result in respect to the defined performance requirement could be the difference between the average customer interaction time measured during the simulation and the average customer interaction time measured during the historical event. Yet another result could be the time required during the simulation for a single customer interaction (as opposed to the times required for multiple customer interactions or an average thereof).

The type and number of results that are monitored, identified and recorded will depend largely on the nature of the design process being tested. In some cases, for instance, it may be necessary or desirable during the simulation to monitor, track and record results such as the quantity of resources (e.g., time, money, people and raw materials) required to carry out the designed process (or a portion thereof), an employee or customer satisfaction level associated with the designed process (or a portion thereof), or a number of accidents, adverse reactions or deaths associated with carrying out the designed process. In other cases, the results may include the number of misunderstandings, criticisms, problems, disputes, disagreements or controversies associated with the designed process. In still other cases, the results may include the number or types of discoveries or inventions attributable to carrying out the designed process, the number of potential customer inquiries, website hits or sales leads generated by using the designed process, and the like. Regardless of how the results are defined, the task of identifying results may be carried out by simulation participants, monitors who do not actually participate in the simulation, or both participants and monitors.

Identifying Deficiencies

Step 180 in FIG. 1 comprises identifying deficiencies in the designed process that are a cause or are in some way at least partly or wholly responsible for one or more results identified in step 170 that are considered to be negative, damaging or destructive in respect to the defined performance requirement. Thus, the step of identifying a deficiency comprises identifying a cause or reason for the negative, damaging or destructive result. If it is determined, for example, that one result of the simulation is that customer support agents require unacceptably long periods of time to resolve customer problems, then insufficient training for customer support agents might be identified as one deficiency partly or wholly responsible for such a result. On the other hand, if the result comprises unacceptably long hold times for customers who call a customer support center to speak to a customer support agent, then the deficiency partly or wholly responsible for that result might be an insufficient number of customer support agents standing by to answer customer calls.

In the embodiment of the invention shown in FIG. 1, the step of conducting the simulation (step 160) also includes the optional step of recording the deficiencies (step 185 of FIG. 1). The inventor of the present invention has found and recognized that designed process testing according to the method herein described is typically more efficient and productive when the participants identify and record deficiencies without immediately trying to address or resolve them. It has been found, for example, that participants attempting to correct deficiencies as they are identified and change performance requirements while the simulation is ongoing often lose focus and find it difficult to stay true to the goal of completing the simulation using the previously well-defined model space. Such loss of focus and difficulties usually compromise the integrity of the simulation and undermines the benefits. On the other hand, superior results are usually achieved when identified deficiencies are quickly recorded (step 185) for attention and analysis at a later time, thereby causing as little interruption as possible to the simulation event itself. One method for quickly recording deficiencies during the simulation comprises utilizing a Kaizen newspaper. Kaizen newspapers adapted for use with the present invention typically comprise, for example, a table containing a row for each identified deficiency, each row containing separate fields indicating: a description of the deficiency; a person or entity responsible for addressing the deficiency; a status indicator, a due date; and remarks or comments about the deficiency.

In some cases, it may be very beneficial during the simulation to assign to an individual or group (who may or may not be a participant in the simulation) with the task of subsequently coming up with an action or solution intended to mitigate a negative result or correct a deficiency. When such an action or solution is later identified (as shown in optional step 190), it is usually advantageous to run the simulation from start to finish a second time after the designed process implementation data, the defined model space, the performance requirements, or all of them, have been modified in order to incorporate the corrective action or solution which addresses the negative result or deficiency (optional step 195 of FIG. 1).

Simulation Leaders

The embodiment shown in FIG. 1 includes the optional step of selecting a simulation leader (step 125 of FIG. 1). The simulation leader will typically undertake responsibilities such as organizing and formatting the implementation and historical event data for easy access by simulation participants, articulating the overall goals of the simulation, keeping the simulation focused and on track for achieving the goals, assigning and changing role playing powers and characteristics, managing the schedule for the simulation, arranging sponsorship and reviews with managers not participating in the simulation, introducing perturbations into the simulation and following up on corrective actions associated with deficiencies identified during the simulation. When special or unanticipated roles, characteristics or decision-making powers are required for the simulation, the simulation leader typically performs those roles, manifests those characteristics or makes those decisions. Alternatively, the simulation leader may assign the special or unanticipated roles, characteristics or decision-making powers to other simulation participants.

Based on the arrangement of the steps and synchronization bars shown in the UML activity diagram of FIG. 1, it should be understood that some of the depicted steps may be performed before, after or concurrently with the performance of other steps without departing from the spirit and scope of the claimed invention. It is noted, for example, that step 110 (collecting implementation data) may be performed before, after or concurrently with the performance of steps 120, 130 and optional step 125, and that optional step 125 may be performed before, after or concurrently with the performance of any of the steps 110, 120, 130, 140 and 150. However, it is usually more advantageous to select a simulation leader (optional step 125) as early as possible, so that the selected simulation leader can help carry out, manage and/or participate in the performance of steps 110, 120, 130, 140 and 150.

Simulation Management Tools

There exists a variety of computerized project modeling tools that may facilitate the steps of defining the model space, defining a performance requirement and conducting the stimulation. Microsoft Project®, for example, is a software-based planning and project management application program developed and sold by Microsoft Corporation (www.microsoft.com) of Redmond, Wash., which assists project managers in developing plans, assigning resources to tasks, tracking progress, and managing budgets and workloads associated with planned projects and processes. Among other things, Microsoft Project® provides the ability to create computer models representing historical or future events associated with very complex processes. Third-party add-ons for Microsoft Project®, such as @Risk®, which is a product developed and sold by Palisade Corporation (www.palisade.com) of Ithaca, N.Y., allows project managers to introduce realistic elements of probability and risk into those created models. An advantage of using computerized modeling tools, such as Microsoft Project® and @Risk®, is they allow users to lay out all of the steps of a very complex designed process, establish links and connections between the various steps based on prerequisite relationships and interdependencies, and isolate and analyze critical paths arising from those prerequisite relationships and interdependencies. Furthermore, access to the computer model enables simulation participants, at any time during the simulation, to gain instantaneous feedback in respect to how the ongoing simulation activities may influence progress in achieving one or more specified performance requirements.

Suppose, for example, the designed process concerns bringing a new drug product to the market. In this case, one of the defined performance requirements is likely to be the step of actually putting the drug product on sale. Suppose further that the historical event data for a previously-marketed drug product shows that achieving regulatory agency approval for the drug product historically required seventy-five weeks, and that twelve of those seventy-five weeks were dedicated to compiling and authoring documents to be included in a new drug application (NDA) submitted to a regulatory approval agency, such as the Food and Drug Administration (FDA). Prior to conducting the simulation, a computer model based on the historical event data may be generated which contains all of the prerequisites and interdependencies connected to putting the product on sale, including the seventy-five week period historically required for achieving the regulatory agency approval and the twelve week period historically required for compiling and authoring the NDA submission documents.

Part way through the simulation, and while the simulation is still ongoing, the simulation participants observe that the new and/or improved strategies, tactics and resources provided by the designed process being tested have enabled the active agents in the simulation to “simulate” completing the NDA submission documents in seven weeks instead of twelve. The reduced time period of seven weeks for completing the NDA submission documents, which would be considered a positive result, can be entered into the computer model at any time during the simulation, and doing so allows the computer model to instantaneously provide forward-looking and continuously-updated projections as to when regulatory approval will now be achieved (based on the reduced time period), as well as when the performance requirement of actually putting the drug product on sale will now be met. Ordinarily, one would expect the performance requirement to be met five weeks earlier. However, that is not necessarily always the case, depending in large part on how the various subtasks and milestones are interdependent upon each other.

On the other hand, it could be discovered part way through the simulation that the active agents in the simulation of the new designed process required twenty-four weeks to complete the NDA submission documents instead of twelve. The increased time period for completing the NDA submission documents, which would be considered a very negative result, can also be entered into the computer model at any time during the simulation, which allows the computer model to instantaneously provide forward-looking and continuously-updated projections as to when regulatory approval will now be achieved (based on the increased time period), as well as when the milestone of actually putting the drug product on sale will now occur. In this case, the participants and simulation leader for the simulation would be encouraged to identify and record a deficiency which caused the extremely negative result. For example, it could be determined by observation during the simulation that the reason for the increased time period was that some of the parties who must review and approve sections of the NDA submission documents lacked sufficient access to the secure computer network where the newly designed process requires that the draft NDA submission documents be stored. Due to the lack of access to the secure computer network, some of the draft NDA submission documents had to be printed, distributed, corrected and returned by hand. Thus, the review and approval process took twice as long to accomplish.

The computer model helps to track, analyze and present these negative and positive results, interdependencies and critical paths in a way that would be extremely difficult to manage without using computerized process modeling technology. Thus, computerized process modeling tools like those described herein, enable the simulation leader and participants to track very complex critical paths existing in a designed process, and further, to change one or more of the variables that affect the critical paths and immediately assess the effect of those changes on one or more specified performance requirements. The simulation leader and the person who manages the computer model may or may not be the same person.

To further describe and illustrate some of the features of the present invention, and to further demonstrate some of the advantages and benefits users are capable of achieving through its practice, a more detailed description of one embodiment of the invention will now be presented.

ACME Biomedical Devices Company observes that it is trailing far behind its competitors in the average length of time it requires to complete human clinical trials for new biomedical devices. A company task force, deployed to analyze the situation and recommend improvements, identifies three key strategies for reducing the time required to complete clinical trials. The three key strategies are: tighter and more effective management of relationships with clinical trial investigators; more accurate extraction, translation and accumulation of clinical trial data for analysis; and more sophisticated statistical analysis capabilities, both in the initial design of the clinical experiments and the final analysis of the clinical trial data obtained from those experiments.

To achieve these key objectives, the task force develops a new clinical trial completion process, called “the Winning Trial Management Process” (or “WTMP”), which includes several new components. First, the task force observes that relationship management would improve if there were a full-time liaison managing the communications and relationships between the company's internal clinicians and the investigators at clinical test sites. The task force decides that, in addition to the clinical trial experience traditionally required for individuals working in this area, the person selected to act as the liaison should also have marketing and sales management experience. Accordingly, the task force creates a new functional role, called the investigator relationship liaison (or “IRL”), and requires that the person performing this new role during clinical trials have marketing and sales management experience. The task force also creates a new manual called “Conducting Effective Clinical Trials,” which includes a new set of standard operating procedures (SOPs) for accumulating and storing clinical trial data. The new SOPs require using a newly-developed trial data entry form (“Form TDEF1”). The WTMP also includes a new training course for designing clinical trials (entitled “Designing Clinical Trials 101”), a new training course for clinical trial investigators (dubbed “Investigator 101”) and a new computer software program (called “EZ-Track”) for designing, demonstrating and statistically analyzing clinical trial experiments.

Although ACME's management believes that using the WTMP will probably reduce the time required to complete clinical trials, it also recognizes the possibility that immediately deploying the newly-designed WTMP across the entire company might produce a significant number of problems, obstacles, expenses, delays, anxieties or injuries that the task force may not have anticipated or fully appreciated when the WTMP was designed. Such unanticipated or underappreciated problems could bring about considerable consequences for the company, the individual workers involved in managing and carrying out clinical trials, or the clinical trial subjects. Therefore, before approving a broad and costly deployment of WTMP, management instructed the task force to organize and conduct a “test” of the newly-designed process using an embodiment of the present invention.

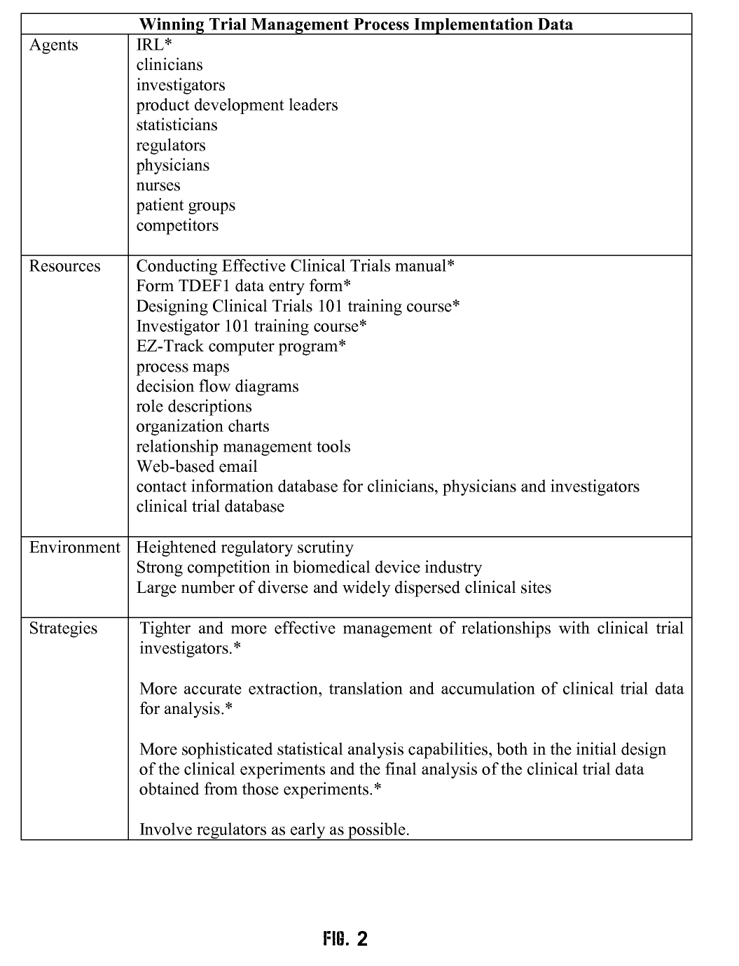

Accordingly, the task force carefully documents data relating to the agents, resources, environment and strategies associated with implementing the newly-developed WTMP, including operating manuals, process maps, decision flow diagrams, data entry forms, images, role descriptions, organization charts, relationship management tools, web-based Internet programs, etc. The table shown in FIG. 2 summarizes the documented implementation data compiled by the task force (asterisks “*” indicate the newly-developed components).

Concurrently with collecting the implementation data, the task force selects a simulation leader, who will be responsible for organizing and managing the simulation. The implementation data is turned over to the simulation leader, who compiles, organizes and formats it so that it may be quickly and efficiently referenced, indexed, searched and accessed by the simulation participants. Additionally, the EZ-Track computer program is acquired, installed and made available for use during the simulation.

Next, the simulation leader and task force identify a suitable historical event that they believe can be simulated using the new components of the WTMP and thereby produce useful information for evaluating the WTMP. In this case, the task force determines that simulating the clinical trial for an endoscope ACME put on the market in the previous calendar year would provide the ideal historical event for evaluating the newly-designed WTMP. Accordingly, the people involved in managing and carrying out the endoscope clinical trials are sought out and recruited to assist with compiling relevant historical data from that event.

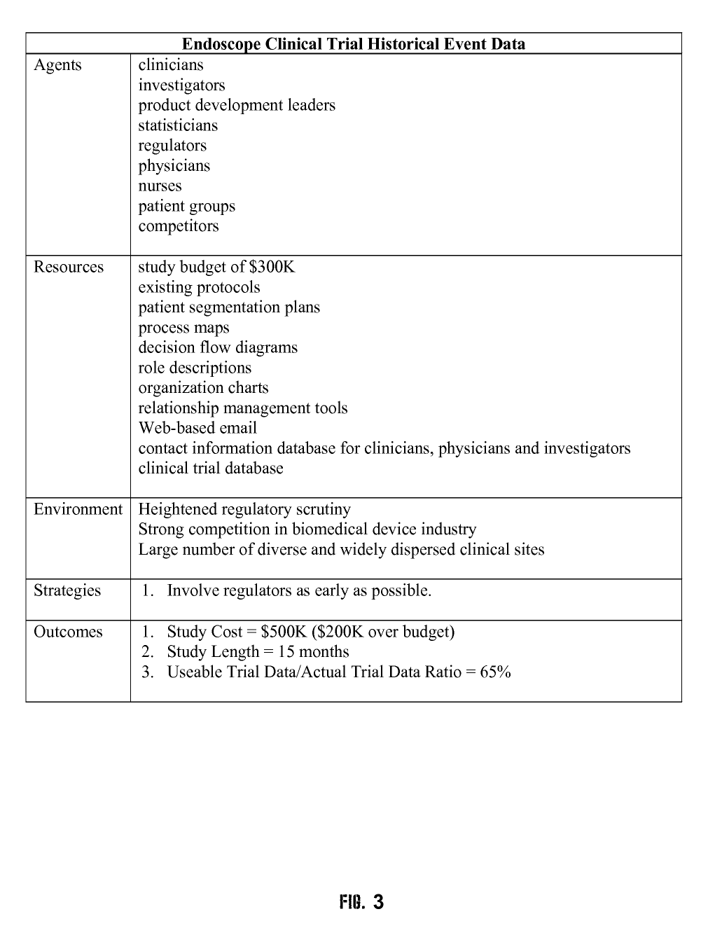

Agents and populations of agents involved with the endoscope clinical trials, such as investigators, statisticians, product development leaders, physicians, patient groups, regulators, and the like, are identified and their involvement over a defined historical timeline is mapped out. Data concerning the resources used during the historical event, such as the study budgets, existing protocols, patient segmentation plans, etc. were amassed as well. Data concerning the internal and external environment parameters pertaining to the historical event, including the investigator sites, the level of competitive and regulatory pressures and associated timelines, etc., are identified, collected, recorded and made available for the simulation participants. Data concerning the strategies employed by the agents involved in the historical event are identified, collected and recorded. Lastly, data pertaining to the outcomes for the endoscope clinical trials are identified, collected and recorded. The outcome data indicates that the clinical trial for the endoscope totaled $500K ($200K over budget) and took 15 months to complete. The outcome documentation also indicates that only 65% of the endoscope clinical trial data was useable. In other words, 35% of the data produced in the clinical trial had to be discarded because it was believed to be inaccurate, irrelevant, flawed or untrustworthy for some other reason. The table shown in FIG. 3 summarizes the historical data collected and/or documented by the task force.

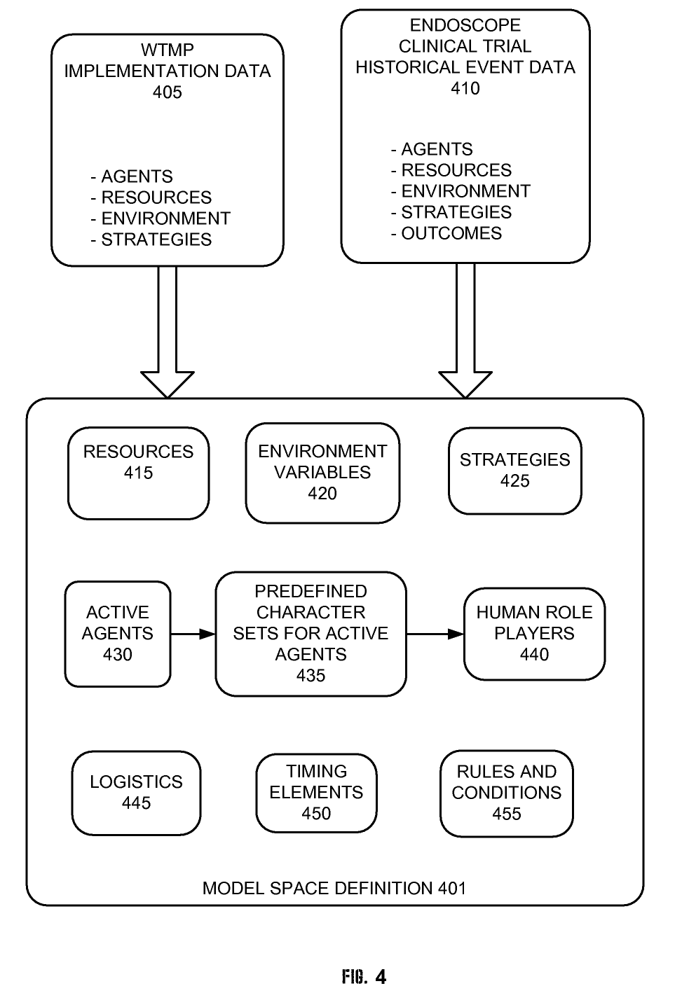

FIG. 4 contains a graphical representation of the model space definition for the simulation. Using the WTMP implementation data 405 and the endoscope clinical trial historical event data 410, the simulation leader and/or task force defines a model space 401 for the simulation. In this case, model space definition 401 includes resources 415, comprising some resources used in the endoscope clinical trial (such as process maps, decision flow diagrams and organization charts), as well as some resources developed specifically for the WTMP (such as the new Form TDEF1 data entry forms, the manual “Conducting Effective Clinical Trials,” the new SOPs for accumulating and storing clinical trial data and the new EZ-Track computer program).

Model space definition 401 also includes environment variables 420, comprising some combination of significant environment elements from the WTMP implementation data 405 and the endoscope clinical trial historical event data 410. In this case, the environment variables include heightened regulatory scrutiny, strong competition in the biomedical device industry and a large number of diverse and widely dispersed clinical sites. Model space definition 401 also includes strategies 425, comprising a combination of the three key strategies developed by the task force for the WTMP process, as well as strategy used during the endoscope clinical trials.

Model space definition 401 also comprises a plurality of active agents 430, a plurality of predefined character sets 435 and a plurality of human role players 440. The plurality of agents includes agents involved in the original development and launch of the endoscope, as well as some new agents expected to be involved in the newly-designed WTMP, including the IRL. Each of the active agents has a predefined character set that will be based at least in part on the resources 415, environment variables 420 and strategies 425 that have been defined for the model space 401. For example, if a committee in the newly-developed WTMP process is expected to render a decision or grant a request based on a key output to be obtained from the EZ-Track computer program, then the model space definition for the simulation should include an active agent corresponding to the committee, a resource corresponding to the EZ-Track computer program, a predefined character set dictating that the committee agent will render the decision or grant the request based on the EZ-Track computer program output. The model space definition will also include a human role player tasked with performing the role of the committee. Finally, the model space definition also includes logistics 445, timing elements 450 and rules and conditions 455. In this case, the simulation leader defines a simulation timeline that spans the original 15 month clinical trial timeline for the endoscope.

The simulation leader uses Microsoft Project® and @Risk® to build a computer model of a new endoscope clinical trial, as defined by model space definition 401, the computer model comprising a variety of inter-related tasks, functions and milestones.

The task force believes the WTMP should produce measurable improvements along the lines of a 30% reduction in resource costs, a 20% reduction in the cycle time in running a trial to completion (this reduction coming primarily from the trial design, administration, data accumulation and analysis stages), and a 15% increase in useable data (defined as data that is free of mistakes, does not need to be reorganized or reformatted, and ready to be used for the formulation of new clinical knowledge about the product). Accordingly, the simulation leader establishes performance requirements that correspond to these anticipated improvements. The simulation also defines several qualitative performance requirements, including increased clarity or roles, improved communication among clinical trial groups, and improved reputation and image.

The simulation is conducted with human participants performing the roles of agents according to their predefined character sets and using the resources and strategies at hand, including for example, the new data entry forms, manuals, training courses, SOPs and computer program. By role playing through the various time elements of the simulation, it is clear that some of the investigators are having a hard time working through the new relationship management scheme. In particular, the simulation reveals many missing handshakes and problematic interaction points associated with documenting and reporting the progress of patients enrolled in the simulated endoscope study. These missing handshakes and problematic interaction points are recorded as gaps and deficiencies of the WTMP.

While the simulation is ongoing, the simulation leader relies on the Microsoft Project® and @Risk computer model to compare the progress and results of the simulated clinical trial to the outcomes of the original historical event of the endoscope study. It is clear from the computer model that two out of the three quantitative performance requirements are being met. However, the computer model shows that the cycle time for the simulated clinical trial is approaching the cycle time for the original historical event. Thus, the 30% reduction in cycle time performance requirement is will not be achieved. The simulation participants identify and record the unreduced cycle time as a result caused by deficiencies in understanding and implementing the new relationship management scheme. These results and deficiencies are recorded using a Kaizen newspaper.

During the third day of the simulation, ACME's management team asks the simulation leader to introduce into the simulation an unplanned perturbation that might occur in real life. To meet this request, the simulation leader announces that the person performing the role of the IRL would not participate in the simulation for the next 4 hours (which equates to 3 months in model space). The simulation leader and management felt that such a perturbation might easily occur in real life when an IRL suddenly becomes unavailable due, for example, to sickness or the need to temporarily work at one of the several clinical trial sites in order to resolve a critical issue. Without the participation of the IRL, the other simulation role players have a difficult time keeping the simulated clinical trial on schedule. Important communications between the clinicians and investigators at multiple clinical trial sites are delayed, misinterpreted or lost altogether, which introduced an unexpectedly high level of confusion among the remaining participants, as well as delays that were much longer than anyone anticipated. It is also discovered that an investigator working at one clinical site is usually ill-equipped to collect and interpret clinical data produced by another clinical trial site. Thus, the perturbation reveals problems, as well as nuances in the functional role played by the IRL, that were previously unrecognized or underappreciated. These problems are also recorded as results of the simulation, which were caused by a deficiency in the cross-training program between clinicians and investigators.

It is clear from the simulation that the task force did not fully understand all of the nuances of implementing the newly-designed WTMP, particularly in the areas where humans had to collaborate and make choices and decisions. After the simulation, design deficiencies recorded in the Kaizen newspaper are explored and corrective actions are developed. The corrective actions are incorporated into the implementation data for the WTMP, which is then incorporated into a new model space. A second simulation is scheduled with the revised implementation data and model space. This simulation will be the final one before the “Winning Trial Management Process” is deployed across the biomedical device firm. However, already the testing process has yielded greater shared understanding (even amongst designers) about the designed process, greater rigor in the documentation of the actual process, established working relationships needed to make the designed process operate more efficiently once implemented, and produced greater confidence in the riskier elements of the design.

Although the exemplary embodiments, uses and advantages of the invention have been disclosed above with a certain degree of particularity, it will be apparent to those skilled in the art upon consideration of this specification and practice of the invention as disclosed herein that alterations and modifications can be made without departing from the spirit or the scope of the invention, which are intended to be limited only by the following claims and equivalents thereof.

What is claimed is:

1. A method for identifying deficiencies in a designed process involving human interaction, judgment and decision-making, the method comprising:
collecting implementation data comprising information pertaining to agents, resources, environment and strategy associated with carrying out the designed process;
identifying a historical event to serve as a context for evaluating the designed process;
compiling historical event data for the historical event, the historical event data including information pertaining to agents, resources, environment, strategy and outcomes associated with the historical event;
defining a model space for a simulation based on the implementation data and the historical event data, the model space including a plurality of roles corresponding respectively to a plurality of agents associated with the historical event, wherein each role in the plurality of roles comprises a predefined character set;
defining a performance requirement for the simulation;
conducting the simulation within the model space, the simulation comprising:
i) a human role player for said each role performing an act in accordance with the predefined character set for said each role,
ii) identifying a result in respect to achieving the performance requirement, and
iii) identifying a deficiency in the designed process that is at least in part responsible for the result.

2. The method of claim 1, wherein defining the model space comprises at least one of:
defining a time period for conducting the simulation,
defining a length of time to be simulated,
defining a set of rules for the simulation,
specifying a location for the simulation,
defining an environment for the simulation,
defining a schedule for the simulation,
identifying a set of resources for the simulation, and
identifying a set of active agents for the simulation.

3. The method of claim 1, further comprising recording the deficiency.

4. The method of claim 1, further comprising introducing a perturbation into the simulation.

5. The method of claim 1, further comprising generating a computer model representing the model space.

6. The method of claim 5, wherein conducting the simulation further comprises utilizing the computer model to determine a status in respect to achieving the performance requirement.

7. The method of claim 1, further comprising:
selecting a simulation leader; and
conducting the simulation under the management of the simulation leader.

8. The method of claim 7, further comprising:
defining a special role for the simulation; and
the simulation leader performing the special role.

9. The method of claim 1, wherein the predefined character set comprises a knowledge characteristic.

10. The method of claim 1, wherein the predefined character set comprises a responsibility characteristic.

11. The method of claim 1, wherein the predefined character set comprises a decision power characteristic.

12. The method of claim 1, wherein the predefined character set comprises a capability characteristic.

13. The method of claim 1, wherein the predefined character set comprises an available resource characteristic.

14. The method of claim 1, further comprising identifying a task which addresses the deficiency.

15. The method of claim 14, wherein the task comprises identifying an action intended to correct the deficiency.

16. The method of claim 15, further comprising:
incorporating the action into the implementation data, thereby producing new implementation data;
incorporating the new implementation data into the model space, thereby producing a new model space; and
conducting a second simulation within the new model space.
